(19) United States
(12) Patent Application Publication
(10) Pub. No.: US 2020/0205376 A1
(43) Pub. Date: Jul. 2, 2020

(54) ARTHROPOD SPRAY STATION DEVICE

(71) Applicant: Tyrone Williams, Boynton Beach, FL (US)

(72) Inventor: Tyrone Williams, Boynton Beach, FL (US)

(21) Appl. No.: 16/235,393

(22) Filed: Dec. 28, 2018

(51) Int. Cl. A01K 13/00; A01N 25/02

(52) U.S. Cl. CPC A01K 13/003; A01N 25/02

(57) ABSTRACT

A device and method for treating a pet or other animal or object to kill or repel an arthropod or other pest species is described. The device is a spray station that includes a storage container having a reservoir for storing a pesticide or repellent composition, a spray nozzle for spraying the composition onto an animal or an object, tubing connecting the reservoir to the spray nozzle, a power source to pump the composition from the storage container through the tubing to the spray nozzle, and an attachment means for connecting the storage container to a substrate such as a floor or a sidewalk. A system is also described for treating a pet or other animal or object to kill or repel an arthropod or other pest species. The system includes a composition such as a pesticide or repellent for repelling or killing an arthropod or other pest species.

### FIELD OF THE INVENTION

The invention relates to systems, devices, and methods for pest control. More particularly, the invention relates to systems, devices, and methods for applying a pesticide or repellent composition to an animal or an object to kill or repel a pest species.

### BACKGROUND

Fleas, ticks, flies, mites, other biting insects, and many other arthropod and non-arthropod pests attack or parasitize animals such as dogs, cats, other pet animals, bovines, horses, hogs and pigs, poultry birds, other livestock animals, zoo or other captive animals, and wild animals. Application of pesticides and repellents to these animals is often used to treat the animal to kill or repel the attacking or parasitizing pest species. Often, however, the animal's owner, handler, or veterinarian must apply such compositions at home, in a barn, in a kennel, or at a veterinary facility. Systems and devices for applying such pesticides and repellents in public locations that are away or remote from the home, barn, kennel, or veterinary facility are not available.

A need exists for systems and devices that can be stationed or installed in public areas such as parks, beaches, sidewalks, and common areas of condominiums and other buildings to allow pesticides, repellents, or both to be applied to pets and other animals to kill or repel attacking and parasitizing arthropods and other pest species.

### SUMMARY

The invention relates to a device and method for treating a pet or other animal or object to kill or repel an arthropod or other pest species. The device is a spray station that includes a storage container having a reservoir for storing a pesticide or repellent composition, a spray nozzle for spraying the composition onto an animal or an object, tubing connecting the reservoir to the spray nozzle, a power source to pump the composition from the storage container through the tubing to the spray nozzle, and an attachment means for connecting the storage container to a substrate such as a floor or a sidewalk. A system is also described for treating a pet or other animal or object to kill or repel an arthropod or other pest species. The system includes a composition such as a pesticide or repellent for repelling or killing an arthropod or other pest species.

Accordingly, the invention features an arthropod spray station system that includes a composition for repelling or killing an arthropod, a storage container having a reservoir for storing the composition; a spray nozzle for spraying the composition onto an animal or an object, tubing connecting the reservoir to the spray nozzle, a power source to pump the composition from the storage container through the tubing to the spray nozzle, and an attachment means for connecting the storage container to a substrate.

In another aspect, the invention can feature the system further including a vacuum pump for pumping flea repellent from the reservoir through the tubing to the spray nozzle.

In another aspect, the invention can feature the attachment means being a base on which the storage container is installed, wherein the base is attached to the substrate.

In another aspect, the invention can feature the composition for repelling or killing the arthropod being or including an insecticide, a parasiticide, a pesticide, a dewormer, a flea repellent, a tick repellent, a mosquito repellent, an arthropod repellent, or a combination of two or more of the foregoing.

In another aspect, the invention can feature the arthropod being or including a flea, a tick, a fly, a mite, a biting insect, or any other pest that attacks or parasitizes the animal.

In another aspect, the invention can feature the animal being or including a dog, a cat, another pet animal, a bovine, a horse, a hog or pig, a poultry bird, another livestock animal, a zoo or other captive animal, or a wild animal.

In another aspect, the invention can feature the system including a button that is actuated to enable the device to spray the composition.

In another aspect, the invention can feature the system further including a timer for spraying the composition for a single use and for discontinuing spraying of the composition after the predetermined period of time expires. The single use is a predetermined period of time.

In another aspect, the invention can feature the system further including a measuring device for spraying the composition for a single use and for discontinuing spraying of the composition after the predetermined amount of composition is depleted. The single use is a predetermined amount of the composition.

The invention also features an arthropod spray station device that includes a storage container for storing a composition for repelling or killing an arthropod, a spray device for spraying the composition onto an animal or an object, tubing connecting the storage container to the spray device, and an ejection device for pumping the composition from the storage container through the tubing to the spray device.

In another aspect, the invention can feature the ejection device being or including a pump or an ejector.

In another aspect, the invention can feature the ejection device being or including a vacuum pump or an air pump.

In another aspect, the invention can feature the device further including an attachment means for connecting the storage container to a substrate.

In another aspect, the invention can feature the device further including a timer for spraying the composition for a single use and for discontinuing spraying of the composition after the predetermined period of time expires. The single use is a predetermined period of time.

In another aspect, the invention can feature the device further including a measuring device for spraying the composition for a single use and for discontinuing spraying of the composition after the predetermined amount of composition is depleted. The single use can be a predetermined amount of the composition.

A method of the invention can be used for repelling or killing an arthropod that attacks or parasitizes an animal. The method includes the step of: (a) spraying a composition for repelling or killing an arthropod onto an animal or an object using an arthropod spray station device that includes: a storage container for storing a composition for repelling or killing an arthropod; a spray device for spraying the composition onto an animal or an object; tubing connecting the storage container to the spray device; and an ejection device for pumping the composition from the storage container through the tubing to the spray device.

Another method of the invention can include the step of: (b) attaching the arthropod spray station device to a substrate using an attachment means for connecting the storage container to the substrate.

Another method of the invention can feature step (a) of the method further including the step of: (c) placing into the storage container the composition, wherein the composition includes an insecticide, a parasiticide, or a combination of two or more of the foregoing.

Another method of the invention can feature step (a) of the method further including the step of: (d) placing into the storage container the composition, wherein the composition includes a flea repellent, a tick repellent, a mosquito repellent, an arthropod repellent, or a combination of two or more of the foregoing.

Another method of the invention can further include one or more of the steps of: (e) providing the spray station device with a timer and using the timer to spray the composition for a single use, wherein the single use is a predetermined period of time, and to discontinue spraying of the composition after the predetermined period of time expires; and/or (f) providing the spray station with a measuring device and using the measuring device to spray the composition for a single use, wherein the single use is a predetermined amount of the composition, and to discontinue spraying of the composition after the predetermined amount of composition is depleted.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a front side view of an arthropod spray device.

FIG. 2 is a front side view of a system for killing, repelling, or both killing and repelling an arthropod that includes the arthropod spray device of FIG. 1 with certain internal components shown in phantom view and a composition for killing, repelling, or both killing and repelling the arthropod shown inside the device's storage container.

FIG. 3 is an exploded view of one exemplary embodiment of an arthropod spray device.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

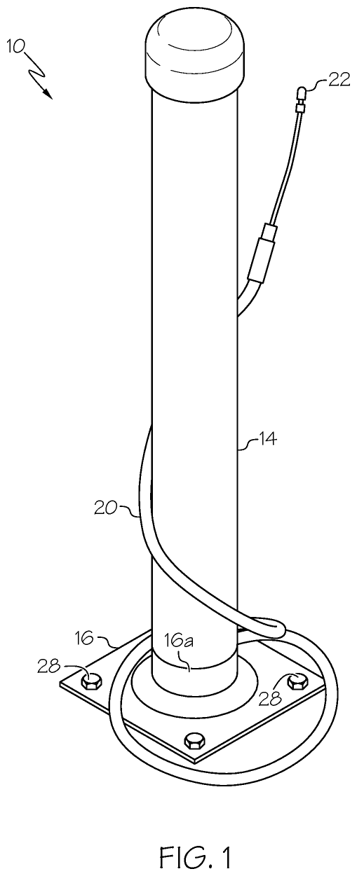

As shown in FIG. 1, the invention provides a system and a device 10 for spraying a composition 12 for repelling or killing an arthropod onto an animal, e.g., onto a dog or a cat, or onto an object. As mentioned, the animal can be a pet animal, e.g., a dog or cat, a livestock animal, a poultry bird, or any other animal. In other embodiments, the animal can be a farm or livestock animal (e.g., a bovine, a horse, a hog or pig, a poultry bird), a zoo or other captive animal, or a wild animal. The object can be an item used with or worn by the animal, e.g., a leash, a saddle, or a collar, or any other object or thing including objects and things not used with or worn by the animal, e.g., a garment, a shoe, a plant, or an automobile.

The arthropod can be a flea, a tick, a fly, a mite, a biting insect, or any other pest that attacks or parasitizes the animal. Although the term “arthropod” as used herein and in the claims is intended to mean species that members of the phylum Arthropoda, for purposes of convenience and without limiting the disclosure related to the inventions described herein, the term is also intended to include non-arthropod species that parasitize or attack animals including various worms (e.g., hookworms, roundworms, and tapeworms) and species that are not animals such as the ringworm fungus. Compositions for killing or repelling such non-arthropod species may now exist or may be developed in the future and can be sprayed using the devices described herein.

The compositions 12 with which the devices, systems, and methods described herein are used include compositions for repelling or killing an arthropod such as an insecticide, a parasiticide, a pesticide, a dewormer, a flea repellent, a tick repellent, a mosquito repellent, an arthropod repellent, or a combination of two or more of the foregoing.

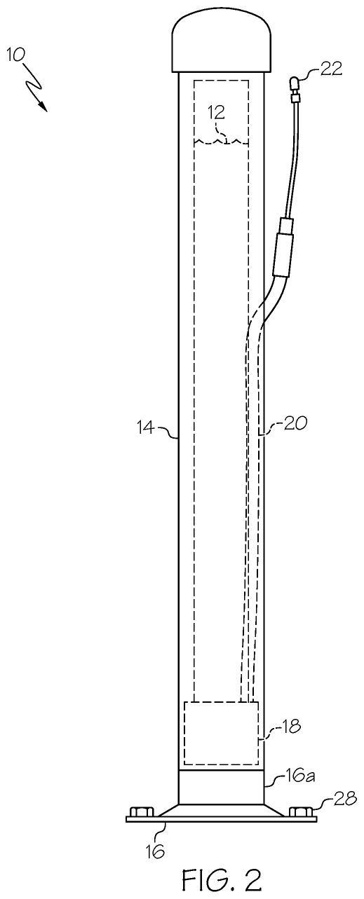

As shown in FIG. 2, the device 10 includes a storage container 14 enclosing an internal reservoir in which composition 12 is stored. The storage container 14 can be an upright storage container in exemplary embodiments. In other embodiments, the storage container may be horizontally oriented when installed. The storage container can be manufactured in any of various shapes such as, for example, a cylinder, a parallelepiped, a prism, a sphere, a dome, or a pyramid. The storage container 14 is constructed from plastic, metal, semimetal, PVC, or any other suitable material. The storage container 14 is constructed from a weather-resistant material in exemplary embodiments.

The storage container 14 includes a closed bottom and an open top. The storage container 14 is refilled with the composition 12 through the open top.

The device 10 can include a base 16 upon which the storage container 14 is removably or permanently attached (e.g., a square or rectangular or circular base). The base 16 can be attached to a substrate, e.g., a paved, asphalt, or concrete surface, or in embodiments without a base, the storage container may be attached directly to the substrate. The substrate can be a sidewalk, parking lot surface, floor, deck, porch, or any other solid surface to which the base can be installed. In some embodiments, the device may not include a base, in which cases, the storage container is installed directly on the substrate. The device can be installed in almost any indoor or outdoor location. For example, the device can be attached to a sidewalk or to a substrate in an airport, a park, a pet store or pet supply store, a pet shelter, a kennel, a pet boarding facility, a veterinary office, a condominium building, apartment building, a housing development, a mobile home park, an RV park, a restaurant, a store, an office, a barn, a farm, a home, a business, an indoor common area of a residential or commercial building, or an outdoor common area of a residential or commercial building. The device can also be installed near a beach or a swimming pool at which pets are allowed access. In exemplary embodiments, the device is installed to a substrate outdoors or in a large ventilated indoor area rather than in a closed confined space. In some embodiments, the substrate can be a wall or a ceiling instead of a floor or other ground-level surface.

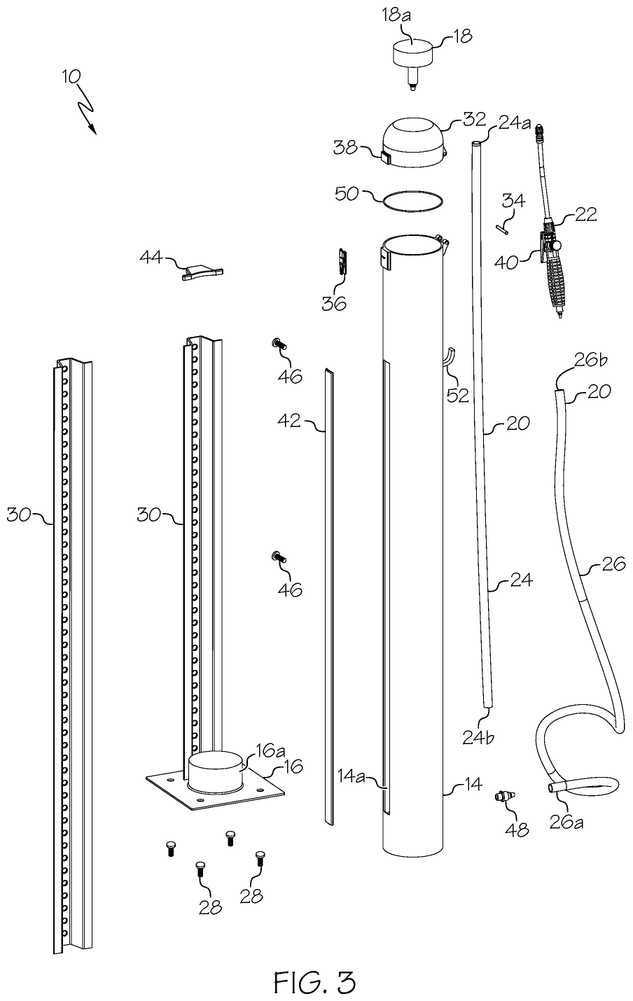

The base 16 can a mount 16a, as shown in FIG. 3, for receiving and holding in place the storage container 14 or a housing in which the storage container is enclosed. The base 16 may be attached to the substrate by bolts 28, screws, nails, stakes, or any other connecting means capable of attaching the base to the substrate to provide stability to and prevent removal of or tipping over of the device. In some embodiments, the base 16 can further include one or more posts 30 that connect to a mount 16a to maintain the storage container 14 (or housing) in an upright, fixed position.

In exemplary embodiments, as shown in FIG. 2, the device 10 can include a pump 18 to move the composition 12 from the storage container 14 through tubing 20 to a spray nozzle 22 for application to an animal or an object. The pump 18 can be a mechanical pump or any other pump that is suitable for moving a liquid from a storage container 14 through tubing 20 and out of a spray nozzle 22. In one exemplary embodiment, the pump 18 can be a pressure pump, as shown in FIG. 3. The pump 18 may be installed above the storage container or below the storage container. Both the pump 18 and the storage container 14 may be enclosed within a housing that is connected to the base 16 of the device. In other embodiments, only one of the pump or the storage container is enclosed within a housing, while the other component is located outside of the housing.

As mentioned above, the device further includes tubing 20. The tubing can be one or more tubes, hoses, or a combination of the foregoing. The tubing 20 (and each segment thereof in embodiments that include two or more segments) includes a first end 20a and a second end 20b. In exemplary embodiments, the tubing 20 has its first end connected to the pump 18 and its second end connected to a spray nozzle 22 for spraying the composition 12 onto an animal or an object. The spray nozzle 22 can be one that includes a trigger handle 40. In other embodiments, the tubing 20 may have its first end connected to the internal reservoir of the storage container and its second end terminating in connection with a spray nozzle for spraying the composition onto an animal or an object. The tubing 20 can be made from plastic, PVC, vinyl, metal, semi-metal, or any other suitable material. The material from which the tubing 20 is made is flexible in exemplary embodiments of the device. In some embodiments that include two segments of tubing 20, an external segment 26 of the tubing, which connects the pump 18 to the spray nozzle 22, is flexible, but The tubing 20 is constructed from a weather-resistant material in exemplary embodiments.

The tubing 20 can be a single tube or two or more segments of tubing. For example, in some embodiments such as the one shown in FIG. 3, the tubing 20 can include an internal fluid pump line hose 24 that connects the internal reservoir of the storage container 14 to the pump 18 and an exterior trigger line hose 26 that connects the pump 18 to the spray nozzle 22. When connected to the pump 18 at its first end 24a, the internal fluid pump line hose 24 may be sufficiently long that its second end 24b, which is open, reaches a bottom of the storage container 14 so that, when the pump is actuated, the composition 12 may be drawn from at or near the bottom of the storage container, thereby avoiding any waste of composition that would occur if the internal fluid pump line hose was too short. As the pump 18 is actuated, composition 12 is drawn from the storage container 14 through the internal fluid pump line hose 20 to the pump. When the spray nozzle 22 is actuated, the composition 12 is then drawn from the pump 18 through the exterior trigger line hose 26, which has its first end 26a connected to the pump, to its second end 26b and into the spray nozzle 22 from which it exits as the composition is sprayed onto an animal or object.

In one embodiment, the device can include a button that must be pressed in order to enable spraying of flea repellent by the device. The device may be operated to spray the flea repellent using any source of power including, for example, a vacuum pump, solar cells or panels, battery, or wired electrical connection. The device can be installed anywhere, both inside or outside residential areas, parks, and other areas where pets are commonly seen.

In one embodiment, to use the device, a user presses a button of the device, which upon being pressed, activates a vacuum pump installed inside or attached to the storage container to pump the flea repellent from the device's internal reservoir through the tubing to the spray nozzle. The flea spray then is emitted from the spray nozzle at the end of the tubing onto an animal to repel fleas and other insects that may already be on the body of the animal or with which the animal may come in contact.

A system for repelling or killing arthropods is also described. The system includes the device, as described herein, and a composition for repelling arthropods, a composition for killing arthropods, or a combination of two or more such compositions. The composition may contain only a pesticide, only a repellent, or both. The composition may also contain only one or multiple pesticides plus only one or multiple repellents. In some embodiments, the composition may contain more than one pesticide or more than one repellent, each of which is effective at killing or repelling a different species of pest.

In some embodiments, the device and system also can feature a timer for spraying the composition for a single use and for discontinuing spraying of the composition after the predetermined period of time expires. The single use is a predetermined period of time. The timer can be mechanical or digital.

In some embodiments, the device and system can also include a measuring device for spraying the composition for a single use and for discontinuing spraying of the composition after the predetermined amount of composition is depleted. The single use is a predetermined amount of the composition. The measuring device can draw the single use from the storage container by pump action. The measuring device may include its own separate pump for drawing the single use from the storage container and may be controlled manually or by electronic means. For example, the device and system may include a controller that includes a processor and memory for activating and deactivating the measuring device pump.

In one exemplary embodiment shown in FIG. 3, the device 10 includes a storage container 14 that is received inside a mount 16a of base 16. The base includes bolts 28 or other connecting means to attach the base in fixed position to a substrate. The bolts 28 may be constructed from stainless steel or any other suitable material, including, for example, other weather-resistant materials. The base 16 also includes one or more posts 30 that are attachable at a bottom end to a top surface of the base and on one or more sides to an outer surface of the storage container 14 (or housing in other embodiments), for example, by mounting bolts 46. The posts 30 assist in maintaining the storage container in a fixed, upright position. The one or more posts 30 may be constructed from stainless steel or any other suitable material, including, for example, other weather-resistant materials. One or more of the posts 30 may include a post cap 44. The post cap 44 protects persons and animals from injury by the exposed top end of the post and can be made from rubber or any other suitable material.

A pressure pump 18 is installed at a top portion of the storage container 14. The pressure pump 18 can be installed in a cap 32 that closes and seals the open end of the storage container 14. A top side of the pressure pump 18 can include a button 18a that is pressed or pumped to actuate the pump, thereby drawing the composition through the tubing 20 to the pump for further distribution to the spray nozzle 22. The pressure pump 18 can have a flush top that is flush with a top surface of a cap 32 that seals the open top of the storage container 14. The cap 32 is constructed from plastic, metal, semimetal, PVC, or any other suitable material. The cap 32 is constructed from a weather-resistant material in exemplary embodiments. The pressure pump 18 is actuated by pressing the flush top, which draws composition out of the storage container through an internal fluid pump line hose or tubing 24 to the pump. When the spray nozzle 22 is actuated, e.g., by pulling a trigger, the composition is forced by the pump 18 through an exterior trigger line hose 26 and out of the spray nozzle 22 onto an animal or an object. The exterior trigger line hose 26 can be connected to the pressure pump 18 by an exterior tube coupling 48. The exterior tube coupling 48 can be made from PVC, plastic, metal, semi-metal, or any other suitable material. The exterior tube coupling 48 is constructed from a weather-resistant material in exemplary embodiments.

In some embodiments, such as the exemplary embodiment shown in FIG. 3, the storage container 14 includes a transparent window 42 installed on the storage container's side wall so that the volume of composition 12 remaining inside the internal reservoir of the storage container may be determined by viewing through the window 42 from outside of the storage container. The storage container 14 can include an aperture 14a (e.g., a vertical aperture that extends from to or near the top portion of the storage container to the storage container's bottom) through its side wall in which the window 42 is installable. The window 42 can be made from acrylic, plastic, glass, or any other suitable material that is transparent and permits a user to look through the material to view the level or volume of composition remaining inside the storage container 14. The window 42 is constructed from a weather-resistant material in exemplary embodiments. The storage container 14 may also include a hook or other retaining device 52 for receiving and holding the tubing 20, e.g., the exterior trigger line hose 26.

The cap 32 may be attached to and seal the open end of the storage container at an O-ring 50 that is placed between an annular edge of the storage container's open top and a bottom annular edge of the cap. The O-ring 50 may be constructed from rubber or other suitable materials for sealing. The cap 32 may be one that is capable of being manually lifted off the storage container's open end. In other embodiments, the cap 32 may include threading so that it may be screwed on and off the storage container's open, which includes corresponding threading. In one embodiment, cap may be attached to the top portion of the storage container by a hinge 34. The hinge 34 permits the cap to be moved up and down to open and close the storage container's open end. The hinge 34 may be constructed from stainless steel or any other suitable material, including, for example, other weather-resistant materials.

In some embodiments, such as the exemplary embodiment shown in FIG. 3, the storage container 14 may include a locking latch 36 installed on an outer wall at its top portion, and the cap 32 may include a locking element 38 that corresponds to and mates with the locking latch 36 when the cap is lowered onto the storage container's top portion. The locking latch 36 holds the cap 32 in place so that the storage container is not accidentally opened by weather, animals, or other occurrence that could knock the cap off of the storage container. The locking latch 36 may also include a lock that is openable by key or by entering a combination to prevent unauthorized users from opening the storage container. The lock may be particularly important where the composition is toxic and also for preventing theft of the composition rather than single uses by users. One or more of the locking latch 36, the locking element 38, and the lock may be constructed from stainless steel or any other suitable material, including, for example, other weather-resistant materials.

The exemplary embodiment of the arthropod spray station device 10 forms a system for spraying an animal or an object to kill (i.e., exterminate), repel, or both kill and repel one or more arthropods or types or species of arthropods once the composition 12 is added to the storage container 14.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An arthropod spray station system comprising:
a composition for repelling or killing an arthropod;
a storage container comprising a reservoir for storing the composition;
a spray nozzle for spraying the composition onto an animal or an object;
tubing connecting the reservoir to the spray nozzle;
a power source to pump the composition from the storage container through the tubing to the spray nozzle; and
an attachment means for connecting the storage container to a substrate.

2. The arthropod spray station system of claim 1, further comprising a vacuum pump for pumping flea repellent from the reservoir through the tubing to the spray nozzle.

3. The arthropod spray station system of claim 1, wherein the attachment means is a base on which the storage container is installed, wherein the base is attached to the substrate.

4. The arthropod spray station system of claim 1, wherein the composition for repelling or killing the arthropod comprises an insecticide, a parasiticide, a pesticide, a dewormer, a flea repellent, a tick repellent, a mosquito repellent, an arthropod repellent, or a combination of two or more of the foregoing.

5. The arthropod spray station system of claim 1, wherein the arthropod comprises a flea, a tick, a fly, a mite, a biting insect, or any other pest that attacks or parasitizes the animal.

6. The arthropod spray station system of claim 1, wherein the animal comprises a dog, a cat, another pet animal, a bovine, a horse, a hog or pig, a poultry bird, another livestock animal, a zoo or other captive animal, or a wild animal.

7. The arthropod spray station system of claim 1, further comprising a button that is actuated to enable the device to spray the composition.

8. The arthropod spray station system of claim 1, further comprising a timer for spraying the composition for a single use, wherein the single use comprises a predetermined period of time, and for discontinuing spraying of the composition after the predetermined period of time expires.

9. The arthropod spray station system of claim 1, further comprising a measuring device for spraying the composition for a single use, wherein the single use comprises a predetermined amount of the composition, and for discontinuing spraying of the composition after the predetermined amount of composition is depleted.

10. An arthropod spray station device comprising:
a storage container for storing a composition for repelling or killing an arthropod;
a spray device for spraying the composition onto an animal or an object;
tubing connecting the storage container to the spray device; and
an ejection device for pumping the composition from the storage container through the tubing to the spray device.

11. The arthropod spray station device of claim 10, wherein the ejection device comprises a pump or an ejector.

12. The arthropod spray station device of claim 10, wherein the ejection device comprises a vacuum pump or an air pump.

13. The arthropod spray station device of claim 10, further comprising an attachment means for connecting the storage container to a substrate.

14. The arthropod spray station device of claim 10, further comprising a timer for spraying the composition for a single use, wherein the single use comprises a predetermined period of time, and for discontinuing spraying of the composition after the predetermined period of time expires.

15. The arthropod spray station device of claim 10, further comprising a measuring device for spraying the composition for a single use, wherein the single use comprises a predetermined amount of the composition, and for discontinuing spraying of the composition after the predetermined amount of composition is depleted.

16. A method for repelling or killing an arthropod that attacks or parasitizes an animal, the method comprising the step of:
(a) spraying a composition for repelling or killing an arthropod onto an animal or an object using an arthropod spray station device comprising:
a storage container for storing a composition for repelling or killing an arthropod;
a spray device for spraying the composition onto an animal or an object;
tubing connecting the storage container to the spray device; and
an ejection device for pumping the composition from the storage container through the tubing to the spray device.

17. The method of claim 16, further comprising the step of:
(b) attaching the arthropod spray station device to a substrate using an attachment means for connecting the storage container to the substrate.

18. The method of claim 16, wherein step (a) of the method further comprises the step of:
(c) placing into the storage container the composition, wherein the composition comprises an insecticide, a parasiticide, or a combination of two or more of the foregoing.

19. The method of claim 16, wherein step (a) of the method further comprises the step of:
(d) placing into the storage container the composition, wherein the composition comprises a flea repellent, a tick repellent, a mosquito repellent, an arthropod repellent, or a combination of two or more of the foregoing.

20. The method of claim 16, further comprising at least one of the steps of:
(e) providing the spray station device with a timer and using the timer to spray the composition for a single use, wherein the single use comprises a predetermined period of time, and to discontinue spraying of the composition after the predetermined period of time expires; and
(f) providing the spray station with a measuring device and using the measuring device to spray the composition for a single use, wherein the single use comprises a predetermined amount of the composition, and to discontinue spraying of the composition after the predetermined amount of composition is depleted.
